(19) United States
(12) Patent Application Publication
(10) Pub. No.: US 2009/0235314 A1
(43) Pub. Date: Sep. 17, 2009

(54) TELEVISION BROADCAST RECEIVING APPARATUS AND CONTROL METHOD THEREFOR

(75) Inventors: Koji Mito, Kawasaki-shi (JP); Kazuna Maruyama, Fuchu-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/398,800

(22) Filed: Mar. 5, 2009

(30) Foreign Application Priority Data
Mar. 11, 2008 (JP) 2008-061286

(51) Int. Cl. H04N 5/445; H04N 5/44

(52) U.S. Cl. 725/50; 348/725; 348/E05.096

(57) ABSTRACT

To provide a television broadcast receiving apparatus capable of receiving image data of a program at a scheduled time and a control method for controlling the apparatus, the broadcast time period of a program broadcasted via a broadcast wave is acquired and stored in a storing unit. If the already-acquired broadcast time period is different from the newly-acquired broadcast time period, the already-acquired broadcast time period is managed as an originally scheduled broadcast time period. When a certain channel is tuned in, if a program whose tuning time is within the originally scheduled broadcast time period exists among programs broadcasted on the tuned channel and having originally scheduled broadcast time periods, the same program broadcasted during the originally scheduled broadcast time period is searched for among programs broadcasted via a network. When the same program has been found, image data of the found program is received.

### BACKGROUND OF THE INVENTION

1. Field of the Invention

The present invention relates to a television broadcast receiving apparatus capable of receiving image data of a program via a network and to a control method for controlling the television broadcast receiving apparatus.

2. Description of the Related Art

In television broadcasting, owing to extension, rainout cancellation, or the like of broadcasting of a sports program such as a live baseball broadcast, the broadcast time periods of the subsequent programs may be changed. In this case, in order to view a program whose broadcast time period has been changed, a user may need to rearrange his or her schedule, for example. In addition, due to a change in the broadcast time period, a failure of scheduled recording of a program, such as a failure of recording of the complete program, may occur. Thus, it is important to appropriately handle such a change in the broadcast time period.

Two methods are available for handling a change in the broadcast time period. As a first method, in a case where the broadcast time period of a program has been changed, the same program that is broadcasted during the originally scheduled time period can be searched for and viewed. To this end, it is necessary to determine whether or not two programs are the same.

As a technique for determining whether or not two programs are the same, a mobile broadcast transmitter/receiver that determines whether or not a program being broadcasted by a broadcasting station and a program being broadcasted by an affiliated station of the broadcasting station are the same on the basis of program information is disclosed, for example, in Japanese Patent Laid-Open No. 2005-311921. In this technology, when a movable body located in a broadcasting area of a broadcasting station enters a broadcasting area of an affiliated station of the broadcasting station, if the same program as a program of the tuned broadcasting station is being broadcasted by the affiliated station, the affiliated station is tuned in.

In addition, as a second method, a change in the broadcast time period of a program can be predicted, so that the change in the broadcast time period can be handled in advance. Regarding such a method, a program reservation device that predicts in advance a program whose broadcast time period is more likely to be changed, by ranking programs in descending order of the number of times the broadcast time period has been changed, is disclosed, for example, in Japanese Patent Laid-Open No. 2002-010149. With this device, in a case where a change in the broadcast time period of a program is predicted, a reservation schedule of the program is corrected so that the change can be handled. Accordingly, a failure of the reservation of the program can be avoided.

However, a user may need to view a program during the originally scheduled time period because, for example, the user cannot arrange a viewing time different from the originally scheduled time.

According to the technique disclosed in Japanese Patent Laid-Open No. 2005-311921, it is determined whether or not a program being broadcasted by a broadcasting station and a program being broadcasted by an affiliated station of the broadcasting station are the same. However, in this technique, the point in which, in a case where the broadcast time period of a program has been changed, the same program that is broadcasted during the originally scheduled time period is searched for is not taken into consideration.

In addition, according to the technique disclosed in Japanese Patent Laid-Open No. 2002-010149, in a case where a change in the broadcast time period of a program is predicted, the change is handled by correcting a reservation schedule. Thus, the program cannot be viewed during the originally scheduled time period.

Consequently, according to the techniques described above, a user who cannot arrange a viewing time different from the originally scheduled time cannot view a program.

### SUMMARY OF THE INVENTION

The present invention provides a television broadcast receiving apparatus that is capable of receiving image data of a program during the originally scheduled time period and a control method for controlling the television broadcast receiving apparatus, and thus improves user friendliness.

According to a first aspect of the present invention, a television broadcast receiving apparatus including a receiving unit capable of receiving image data of programs via a broadcast wave and a network includes an acquisition unit configured to acquire a broadcast time period of a program broadcasted via the broadcast wave; a storing control unit configured to cause a storing unit to store the broadcast time period acquired by the acquisition unit; a determining unit configured to compare, in a case where the acquisition unit acquires the broadcast time period of the program broadcasted via the broadcast wave, the broadcast time period with an already-acquired broadcast time period of the program that has been acquired and stored in the storing unit, and to determine, in a case where the broadcast time period and the already-acquired broadcast time period differ from each other, that the broadcast time period of the program has been changed; a setting unit configured to set, as an originally scheduled broadcast time period, an originally scheduled broadcast time period of a program for which it is determined by the determining unit that the broadcast time period has been changed, in the storing unit; an instructing unit configured to issue an instruction of tuning to a broadcast wave channel; a search unit configured to search for, in a case where a program whose tuning time is within the originally scheduled broadcast time period exists among programs that are scheduled to be broadcasted on the channel tuned in accordance with the instruction from the instructing unit and that have originally scheduled broadcast time periods, among programs broadcasted via the network, the same program that is scheduled to be broadcasted during the originally scheduled broadcast time period of the program; and a control unit configured to control, in a case where the same program has been found by the search unit, the receiving unit to receive image data of the found program.

According to a second aspect of the present invention, a television broadcast receiving apparatus including a receiving unit capable of receiving image data of programs via a broadcast wave and a network includes an acquisition unit configured to acquire a broadcast time period of a program broadcasted via the broadcast wave; a storing control unit configured to cause a storing unit to store the broadcast time period acquired by the acquisition unit; a determining unit configured to compare, in a case where the acquisition unit acquires the broadcast time period of the program broadcasted via the broadcast wave, the broadcast time period with an already-acquired broadcast time period of the program that has been acquired and stored in the storing unit, and to determine, in a case where the broadcast time period and the already-acquired broadcast time period differ from each other, that the broadcast time period of the program has been changed; a setting unit configured to set, as an originally scheduled broadcast time period, an originally scheduled broadcast time period of a program for which it is determined by the determining unit that the broadcast time period has been changed, in the storing unit; a display control unit configured to cause a display unit to display an electronic program guide for programs broadcasted via the broadcast wave; a selecting unit configured to select a program on the electronic program guide; a search unit configured to search for, in a case where the program selected by the selecting unit is the program for which it is determined by the determining unit that the broadcast time period has been changed, among programs broadcasted via the network, the same program that is scheduled to be broadcasted during the same broadcast time period as the originally scheduled broadcast time period of the program selected by the selecting unit; and a control unit configured to control, in a case where the same program has been found by the search unit, the receiving unit to receive image data of the found program.

According to a third aspect of the present invention, a television broadcast receiving apparatus including a receiving unit capable of receiving image data of programs via a broadcast wave and a network includes an acquisition unit configured to acquire a broadcast time period of a program broadcasted via the broadcast wave; a storing control unit configured to cause a storing unit to store the broadcast time period acquired by the acquisition unit; a determining unit configured to compare, in a case where the acquisition unit acquires the broadcast time period of the program broadcasted via the broadcast wave, the broadcast time period with an already-acquired broadcast time period of the program that has been acquired and stored in the storing unit, and to determine, in a case where the broadcast time period and the already-acquired broadcast time period differ from each other, that the broadcast time period of the program has been changed; a setting unit configured to set, as an originally scheduled broadcast time period, an originally scheduled broadcast time period of a program for which it is determined by the determining unit that the broadcast time period has been changed, in the storing unit; a search unit configured to search for, in a case where a program broadcasted via the broadcast wave for which a viewing reservation has been made is the program for which it is determined by the determining unit that the broadcast time period has been changed, among programs broadcasted via the network, the same program that is scheduled to be broadcasted during the same broadcast time period as the originally scheduled broadcast time period of the reserved program stored in the storing unit, before the reserved viewing is performed; and a control unit configured to control, in a case where the same program has been found by the search unit, the receiving unit to receive image data of the found program.

According to a fourth aspect of the present invention, a television broadcast receiving apparatus including a receiving unit capable of receiving image data of programs via a broadcast wave and a network and program information on the programs includes a determining unit configured to determine whether or not a broadcast time period of a program broadcasted via the broadcast wave has a possibility of being changed, on the basis of program information on the program received by the receiving unit; a selecting unit configured to select a program broadcasted via the broadcast wave; a search unit configured to search for, in a case where the determining unit determines that the broadcast time period of the program selected by the selecting unit has a possibility of being changed, among programs broadcasted via the network, the same program whose broadcast time period has no possibility of being changed, on the basis of the program information on the program received by the receiving unit; a generating unit configured to generate, in a case where the same program has been found by the search unit, reservation information on a viewing reservation of the found program; a storing unit configured to store the reservation information generated by the generating unit; and a control unit configured to control the receiving unit to receive image data of the found program for which the viewing reservation has been made, on the basis of the reservation information stored in the storing unit.

Other features and aspects of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 illustrates an example of a television broadcast receiving system according to a first embodiment of the present invention.

FIG. 2 is a block diagram schematically showing the configuration of a television broadcast receiving apparatus according to the first embodiment of the present invention.

FIG. 3 shows an example of a channel table used in the first embodiment of the present invention.

FIG. 4 shows an example of a broadcast time period change management table used in the first embodiment of the present invention.

FIG. 5 shows an example of a same program list used in the first embodiment of the present invention.

FIG. 6 is a flowchart showing a broadcast time period change setting process according to the first embodiment of the present invention.

FIG. 7 is a flowchart showing a tuning process according to the first embodiment of the present invention.

FIG. 8 shows an example of a tuning confirmation screen used in the first embodiment of the present invention.

FIG. 9 shows an example of channel selection screen used in the first embodiment of the present invention.

FIG. 10 is a flowchart showing a program search process according to the first embodiment of the present invention.

FIG. 11 is a flowchart showing a broadcast time period change setting process according to a modification of the first embodiment of the present invention.

FIG. 12 is a flowchart showing a tuning process according to the modification of the first embodiment of the present invention.

FIG. 13 shows an example of an electronic program guide including the latest program schedule and the original program schedule before changes of broadcast time periods used in a second embodiment of the present invention.

FIG. 14 is a flowchart showing a program selecting process according to the second embodiment of the present invention.

FIG. 15 is a flowchart showing a reservation execution process according to a third embodiment of the present invention.

FIG. 16 shows an example of a reservation candidate program list used in a fourth embodiment of the present invention.

FIG. 17 is a flowchart showing a reservation registration process according to the fourth embodiment of the present invention.

FIG. 18 shows an example of a reservation program selection screen used in the fourth embodiment of the present invention.

### DESCRIPTION OF THE EMBODIMENTS

Exemplary embodiments of the present invention will now be described in detail in accordance with the accompanying drawings.

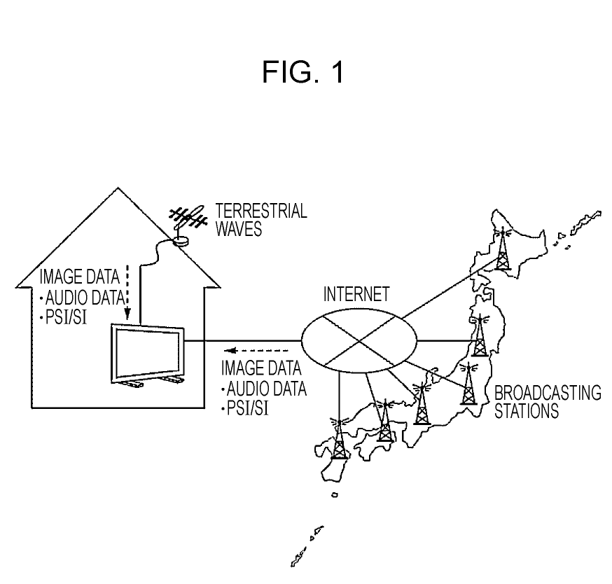

Referring to FIG. 1, a television broadcast receiving apparatus according to a first embodiment is capable of receiving local television broadcasts via terrestrial waves and receiving nation-wide television broadcasts via Internet protocol (IP) broadcasting. Image data, audio data, program specific information (PSI), and service information (SI) of local television broadcasts can be received via terrestrial broadcasting. Meanwhile, image data, audio data, PSI, and SI of nation-wide television broadcasts can be received via IP broadcasting.

In general, a program broadcasted by a television broadcasting station in an area may also be broadcasted by a television broadcasting station in a different area. In addition, the program schedule of television broadcasts may differ depending on the area. Thus, even in a case where the broadcast time period of a program to be broadcasted by a television broadcasting station in an area has been changed, the broadcast time period of the same program to be broadcasted by a television broadcasting station in a different area is not necessarily changed.

Thus, in a case where the broadcast time period of a program via terrestrial broadcasting has been changed, the television broadcast receiving apparatus according to the first embodiment may be capable of receiving image data and audio data of the same program via IP broadcasting during the originally scheduled time period. Here, a change in the broadcast time period may be, for example, a delay in the broadcast start time of a program due to extension of the broadcast time period of a sports program or the like, an advance of the broadcast start time of a program due to cancellation of a sports program or the like, or cancellation of a program due to rainout or the like.

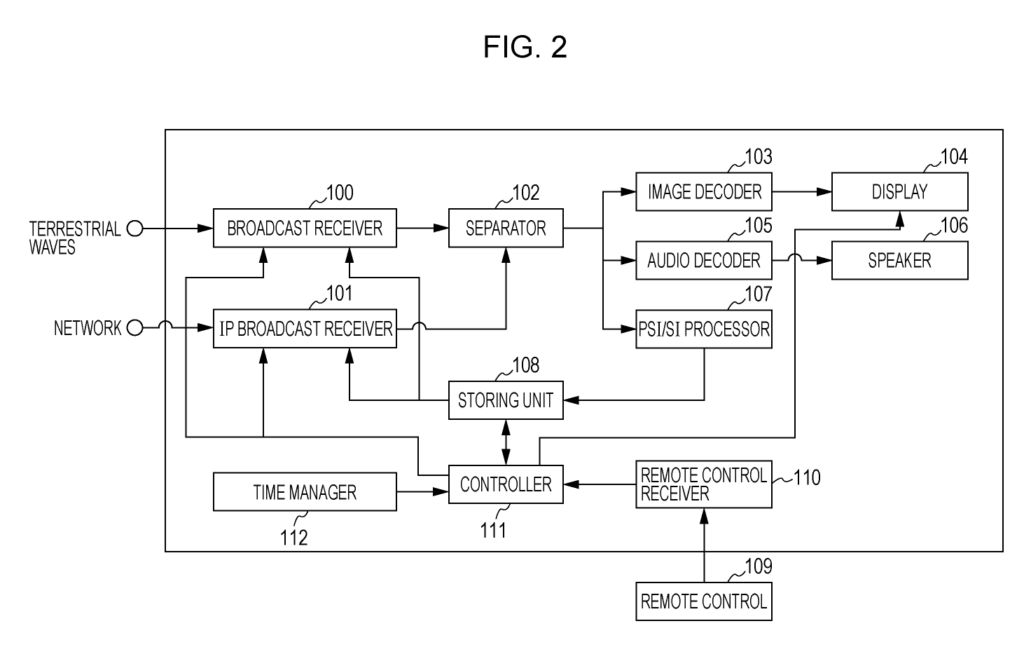

FIG. 2 is a block diagram schematically showing the configuration of the television broadcast receiving apparatus according to the first embodiment of the present invention. In this embodiment, a television broadcast receiving apparatus that is capable of being connected to a network is assumed as the television broadcast receiving apparatus according to this embodiment.

A broadcast receiver 100 receives terrestrial waves and extracts a modulation signal in a desired channel. Then, the broadcast receiver 100 performs processing, such as demodulation and error correction, on the extracted signal to generate digital data in a transport stream (TS) format. Then, the broadcast receiver 100 outputs the generated TS data to a separator 102. Note that image data, audio data, and the like of a program are time-division multiplexed on TS data.

An IP broadcast receiver 101 acquires TS data in a moving picture experts group (MPEG) format stored in the payload of an IP broadcast packet received via a connected network. Then, the IP broadcast receiver 101 outputs the acquired TS data to the separator 102.

The separator 102 receives TS data from the broadcast receiver 100 and the IP broadcast receiver 101. Then, the separator 102 acquires image data, audio data, and PSI and SI serving as program information from the received TS data. Then, the separator 102 outputs the image data to an image decoder 103, outputs the audio data to an audio decoder 105, and outputs the PSI and SI to a PSI/SI processor 107.

PSI is constituted by a network information table (NIT) and the like. Information on a transmission channel, such as information indicating a center frequency, is described in the NIT.

In addition, SI is constituted by an event information table (EIT), a broadcaster information table (BIT), a service description table (SDT), and the like. Information on a program, such as information indicating the name of the program and the broadcast time period of the program, is described in the EIT. Information on a broadcaster, such as information on the identifier for identifying the broadcaster and affiliate identification information for identifying an affiliated station, is described in the BIT. Information on a channel, such as information on the name of the channel and the name of a broadcaster, is described in the SDT.

The image decoder 103 decodes the image data received from the separator 102. Then, the image decoder 103 outputs the decoded image data to a display 104, which serves as a display unit. The display 104 displays an image on the basis of the image data received from the image decoder 103.

The audio decoder 105 decodes the audio data received from the separator 102. Then, the audio decoder 105 outputs the decoded audio data to a speaker 106. The speaker 106 outputs sound on the basis of the audio data received from the audio decoder 105.

The PSI/SI processor 107 decodes the PSI and the SI received from the separator 102. Then, the PSI/SI processor 107 outputs the decoded PSI and SI to a storing unit 108.

The storing unit 108 stores the PSI and the SI received from the PSI/SI processor 107. Note that in the description below, a controller 111, which will be described later, always uses the latest EIT stored in the storing unit 108.

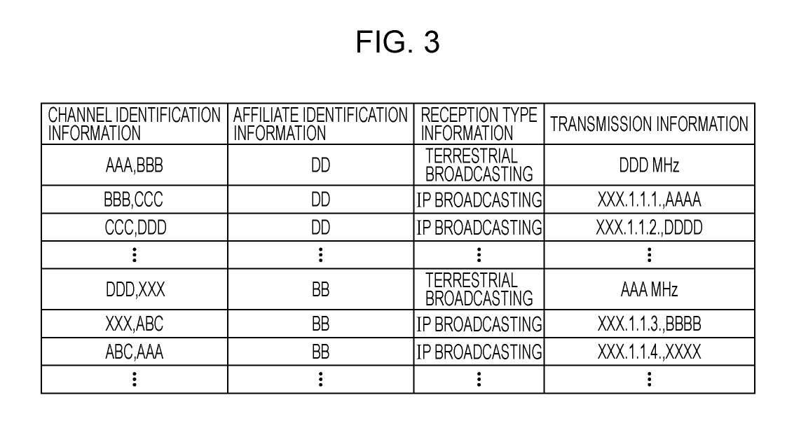

In addition, the storing unit 108 stores a channel table where channel identification information, affiliate identification information, reception type information, and transmission information are associated with each other, as shown in FIG. 3. Information on the channel table is set under the control of the controller 111.

The channel identification information is information for identifying a channel. In this embodiment, a network identifier and a service identifier are used as channel identification information. Note that a network identifier and a service identifier are contained in the NIT. In addition, the affiliate identification information is information for identifying an affiliate of a broadcaster. The reception type information is information indicating a broadcasting system (terrestrial broadcasting or IP broadcasting). In the case of terrestrial broadcasting, the transmission information indicates a frequency. Meanwhile, in the case of IP broadcasting, the transmission information indicates a destination address and a destination port number of a packet to be used for IP broadcasting.

In this embodiment, the descriptor of the NIT contained in the PSI of IP broadcasts is extended so that an address and a port number can be described. In the extended NIT, a destination address and a destination port number of a packet to be used for IP broadcasting are described.

In the description below, a “channel” of IP broadcasting represents a destination address and a destination port number of a packet multicasted from a distribution server for IP broadcasting. In addition, “tuning” to an IP broadcast channel represents receiving a packet that is provided with a particular destination address and a particular destination port number and that is multicasted from a distribution server for IP broadcasting.

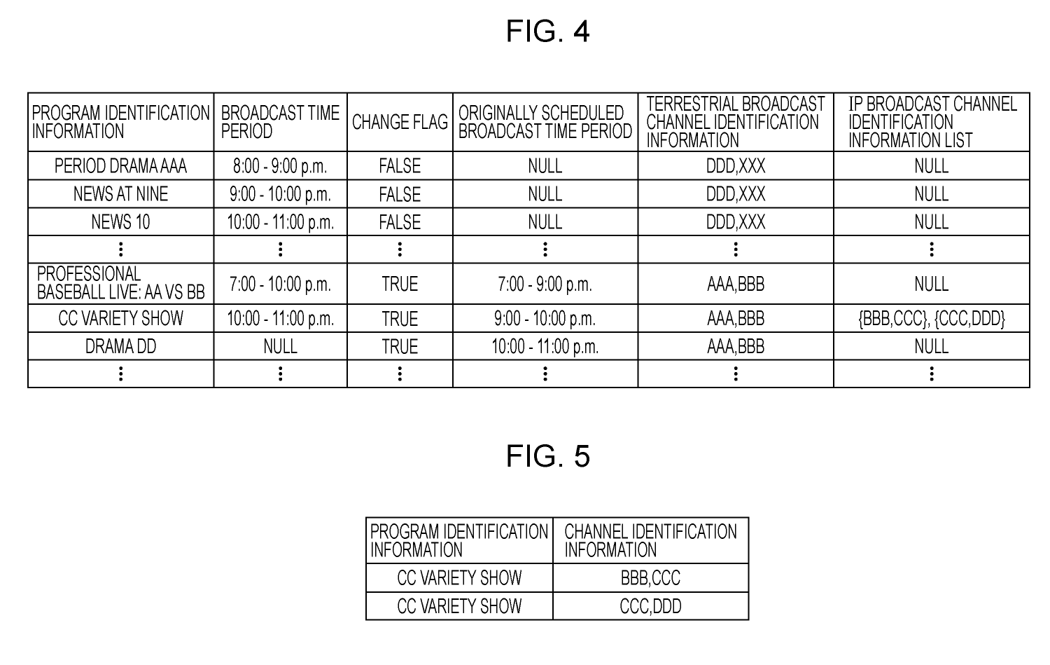

In addition, the storing unit 108 stores a broadcast time period change management table where program identification information, a broadcast time period, a change flag, an originally scheduled broadcast time period, terrestrial broadcast channel identification information, and an IP broadcast channel identification information list are associated with each other, as shown in FIG. 4. Information on the broadcast time period change management table is set under the control of the controller 111.

The broadcast time period change management table will now be described in detail. The program identification information is information for identifying a program. In this embodiment, the name of a program is used as program identification information. However, in the present invention, program identification information is not necessarily a program name. Any type of information can be used as long as a program can be identified on the basis of the information. In addition, the broadcast time period represents the broadcast time period of a program. In a case where broadcasting of a program is canceled, the broadcast time period exhibits a value “NULL”.

The change flag indicates whether or not the broadcast time period of a program has been changed. In a case where the broadcast time period of a program has been changed, the change flag exhibits a value “TRUE”. Meanwhile, in a case where the broadcast time period of a program has not been changed, the change flag exhibits a value “FALSE”. Although the determination of whether or not the broadcast time period of a program has been changed is not performed on the basis of the change flag in this embodiment, the determination of whether or not the broadcast time period of a program has been changed is performed on the basis of the change flag in a third embodiment, which will be described later.

In a case where the broadcast time period of a program has been changed, the originally scheduled broadcast time period indicates the originally scheduled broadcast time period. Meanwhile, in a case where the broadcast time period of a program has not been changed, the originally scheduled broadcast time period exhibits a value “NULL”. The terrestrial broadcast channel identification information is channel identification information on a terrestrial broadcast channel. The IP broadcast channel identification information list is a list of channel identification information on IP broadcast channels on which the same program as a terrestrial broadcast program whose broadcast time period has been changed is broadcasted during the originally scheduled broadcast time period. In a case where the broadcast time period of a program has not been changed or in a case where a corresponding IP broadcast channel does not exist, the IP broadcast channel identification information list exhibits a value “NULL”.

In addition, the storing unit 108 stores a same program list to be used for a tuning process, which will be described later. The same program list is a list where program identification information on a program that is the same as a terrestrial broadcast program and that is broadcasted via IP broadcasting and channel identification information on an IP broadcast channel on which the program is broadcasted are associated with each other, as shown in FIG. 5.

A remote control 109 includes a tuning key, a cursor key, a set key, and an electronic program guide key. The tuning key is used for issuing a tuning instruction. The cursor key is used for issuing an instruction to move a highlighted portion on a selection screen. The set key is used for issuing an instruction to select one of the options highlighted on the selection screen. The electronic program guide key is used for issuing an instruction to display an electronic program guide for terrestrial broadcasts. The remote control 109 transmits the above-mentioned instructions to a remote control receiver 110. The remote control receiver 110 receives an instruction from the remote control 109, and transmits the received instruction to the controller 111.

In the description below, a case where a user operates the television broadcast receiving apparatus according to this embodiment by using the remote control 109 will be described. However, an equivalent operation can be performed even in a case where an operation unit (not illustrated) provided in the main body of the television broadcast receiving apparatus is operated.

The controller 111 acquires PSI and SI from the storing unit 108. Then, the controller 111 sets information in the channel table on the basis of, for example, the NIT contained in the PSI and the BIT contained in the SI acquired from the storing unit 108. Such a setting process is performed, for example, when the television broadcast receiving apparatus is installed. In this embodiment, information to be set in the channel table is acquired from the NIT, the BIT, and the like, and set. However, in the present invention, information to be set in the channel table is not necessarily acquired as described above. For example, information to be set in the channel table may be acquired from a server operated by a broadcaster, and set.

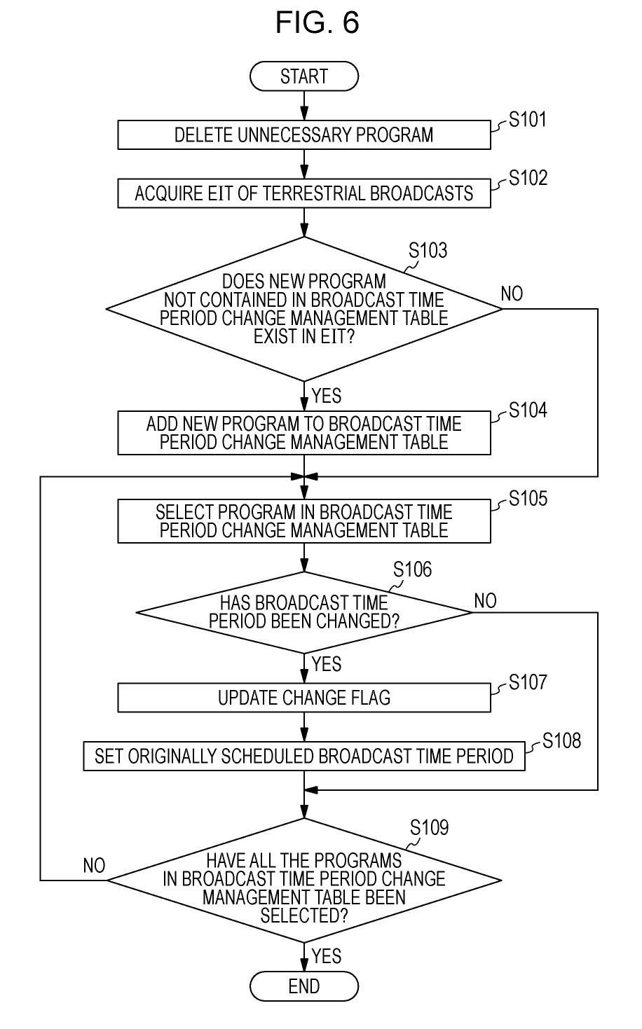

In addition, the controller 111 sets information in the broadcast time period change management table on the basis of the PSI and SI of terrestrial broadcasts stored in the storing unit 108. Such a broadcast time period change setting process performed by the controller 111 will be described later with reference to FIGS. 4 and 6.

In addition, the controller 111 receives a tuning instruction from the remote control receiver 110. When receiving a tuning instruction of tuning to a terrestrial broadcast channel, the controller 111 notifies the broadcast receiver 100 of channel identification information for identifying the channel. Meanwhile, when receiving a tuning instruction of tuning to an IP broadcast channel, the controller 111 notifies the IP broadcast receiver 101 of channel identification information for identifying the channel.

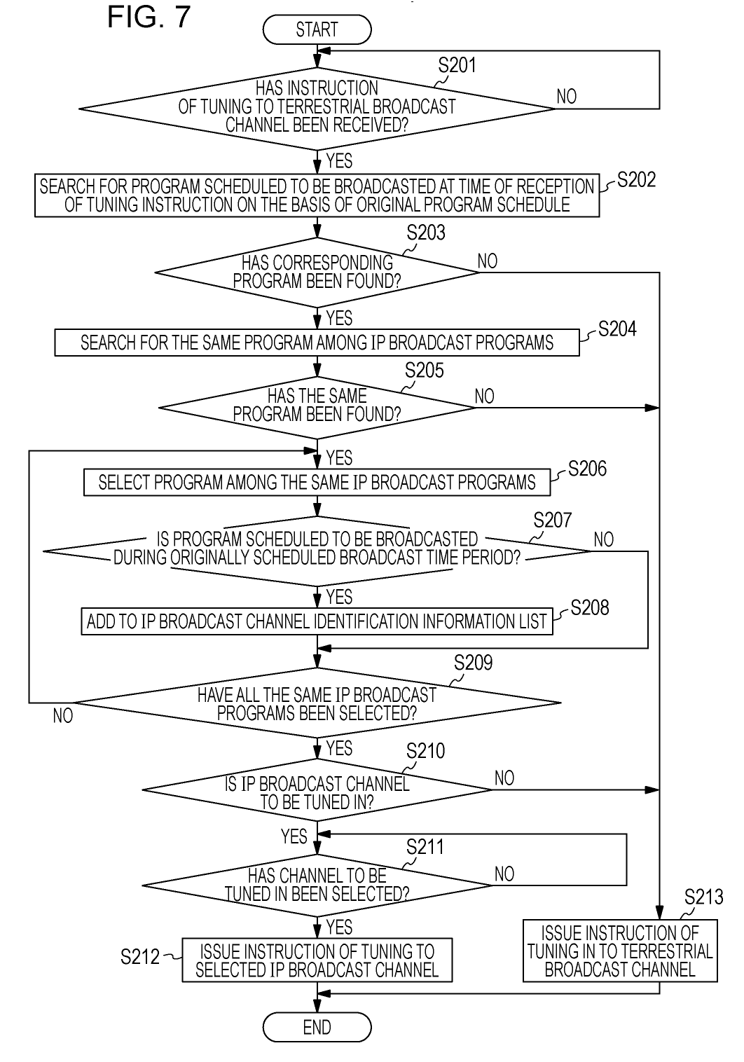

In particular, in a case where the broadcast time period of a program broadcasted on a terrestrial broadcast channel for which a tuning instruction has been issued is changed, the controller 111 issues a tuning instruction of tuning to an IP broadcast channel on which the same program is scheduled to be broadcasted during the originally scheduled broadcast time period. Such a tuning process performed by the controller 111 will be described later with reference to FIG. 7.

In addition, the controller 111 has a display control function of displaying a selection screen, an electronic program guide, and the like on the display 104. A time manager 112 manages the current time.

The broadcast receiver 100 acquires, from the channel table, transmission information that is associated with the channel identification information notified from the controller 111, and extracts a modulation signal of the channel based on a frequency indicated by the transmission information. Similarly, the IP broadcast receiver 101 acquires, from the channel table, transmission information that is associated with the channel identification information notified from the controller 111. Then, the IP broadcast receiver 101 is tuned in to an IP broadcast channel based on an IP address and a port number represented by the transmission information.

A broadcast time period change setting process for setting, in a broadcast time period change management table, information on a terrestrial broadcast program whose broadcast time period has been changed will now be described. The broadcast time period change setting process is performed by the controller 111 on the basis of the PSI and SI of terrestrial broadcasts. FIG. 6 is a flowchart showing the broadcast time period change setting process performed by the controller 111. The broadcast time period change setting process is performed at a time when the television broadcast receiving apparatus acquires the SI of terrestrial broadcasts. The SI of terrestrial broadcasts is acquired at the time of tuning and when a user is not viewing a program. In particular, during the time period when the user is not viewing a program, the television broadcast receiving apparatus is automatically tuned in to each of all the terrestrial broadcasting stations preset in the television broadcast receiving apparatus and acquires the SI of all the stations.

In step S101, the controller 111 deletes an unnecessary program from the broadcast time period change management table stored in the storing unit 108. Specifically, on the basis of the current time acquired from the time manager 112, the controller 111 deletes, from the broadcast time period change management table stored in the storing unit 108, information on a program whose broadcast time period and originally scheduled broadcast time period have ended. Note that in the broadcast time period change management table, in the case of a program whose broadcast time period exhibits a value “NULL”, it is determined that the broadcast time period of the program has ended. In addition, in the case of a program whose originally scheduled broadcast time period exhibits a value “NULL”, it is determined that the originally scheduled broadcast time period of the program has ended.

In step S102, the controller 111 acquires the EIT of terrestrial broadcasts from the storing unit 108.

In step S103, the controller 111 determines whether or not a new program not contained in the broadcast time period change management table stored in the storing unit 108 exists in the EIT acquired in step S102. In a case where it is determined that a new program not contained in the broadcast time period change management table exists in the EIT acquired in step S102 (YES in step S103), the controller 111 proceeds to step S104. Meanwhile, in a case where it is determined that a new program not contained in the broadcast time period change management table does not exist in the EIT acquired in step S102 (NO in step S103), the controller 111 proceeds to step S105.

In step S104, the controller 111 adds, to the broadcast time period change management table, information on the new program that is determined in step S103 to exist in the EIT acquired in step S102. First, the controller 111 adds, to the broadcast time period change management table stored in the storing unit 108, the name of the new program existing in the EIT acquired in step S102 as program identification information.

Then, the controller 111 sets the broadcast time period of the new program existing in the EIT acquired in step S102 in association with the added program identification information. Then, on the basis of the PSI stored in the storing unit 108, the controller 111 sets, in association with the added program identification information, channel identification information on a terrestrial broadcast channel on which the new program is scheduled to be broadcasted. Furthermore, the controller 111 sets, in association with the added program identification information, the change flag which exhibits a value “FALSE”, the originally scheduled broadcast time period which exhibits a value “NULL”, and an IP broadcast channel identification information list which exhibits a value “NULL”.

In step S105, the controller 111 selects a program from the broadcast time period change management table.

In step S106, on the basis of the EIT acquired in step S102, the controller 111 determines whether or not the broadcast time period of the program selected in step S105 has been changed. Specifically, in a case where condition (1) or (2) is met, the controller 111 determines that the broadcast time period of the program selected in step S105 has been changed.

Condition (1): A case where the EIT of the program selected in step S105 exists in the EIT acquired in step S102 and the broadcast time period of the program existing in the EIT is different from the broadcast time period associated with program identification information for identifying the program in the broadcast time period change management table. Here, the broadcast time period of the program described in the broadcast time period change management table has already been acquired before the acquisition of the EIT. This case may occur, for example, when the start of broadcasting of the program selected in step S105 is delayed due to extension of the broadcast time period of a sports program or the like or when the start of broadcasting is advanced due to cancellation of a sports program or the like.

Condition (2): A case where the EIT of the program selected in step S105 does not exist in the EIT acquired in step S102. This case may occur, for example, when broadcasting of the program selected in step S105 is canceled.

In a case where neither condition (1) nor (2) is met, the controller 111 determines that the broadcast time period of the program selected in step S105 has not been changed. In a case where it is determined that the broadcast time period of the program selected in step S105 has been changed (YES in step S106), the controller 111 proceeds to step S107. In a case where it is determined that the broadcast time period of the program selected in step S105 has not been changed (NO in step S106), the controller 111 proceeds to step S109.

In step S107, the controller 111 updates the value of the change flag that is associated with the program identification information for identifying the program selected step S105 in the broadcast time period change management table to “TRUE”.

In step S108, the controller 111 acquires, from the broadcast time period change management table, the broadcast time period that is associated with the program identification information for identifying the program selected in step S105. Then, the controller 111 updates, to the acquired broadcast time period, the originally scheduled broadcast time period that is associated with the program identification information for identifying the selected program in the broadcast time period change management table.

In addition, in a case where the EIT of the program selected in step S105 exists in the EIT acquired in step S102, the controller 111 acquires the broadcast time period of the selected program from the EIT. Then, the controller 111 updates, to the acquired broadcast time period, the broadcast time period that is associated with the program identification information for identifying the selected program in the broadcast time period change management table. Meanwhile, in a case where the EIT of the selected program does not exist in the EIT acquired in step S102, the controller 111 updates, to “NULL”, the value of the broadcast time period that is associated with the program identification information for identifying the selected program in the broadcast time period change management table.

In step S109, the controller 111 determines whether or not all the programs in the broadcast time period change management table have been selected in step S105. In a case where all the programs have not been selected (NO in step S109), the controller 111 returns to step S105 and continues to perform the process by selecting a new program from the broadcast time period change management table. Meanwhile, in a case where all the programs in the broadcast time period change management table have been selected (YES in step S109), the controller 111 ends the process.

Note that in the broadcast time period change setting process in this embodiment, information is set in the broadcast time period change management table on the basis of PSI and SI acquired via terrestrial broadcasting. However, such information is not necessarily set as described above. For example, such information may be acquired from a server on the Internet operated by a broadcaster, and the acquired information may be set in the broadcast time period change management table.

A tuning process for tuning to an IP broadcast channel on which the same program as a terrestrial broadcast program whose broadcast time period has been changed is broadcasted during the originally scheduled broadcast time period will now be described. The tuning process is performed by the controller 111. FIG. 7 is a flowchart showing the tuning process performed by the controller 111.

In step S201, the controller 111 determines whether or not a tuning instruction of tuning to a terrestrial broadcast channel has been received from the remote control receiver 110. In a case where it is determined that a tuning instruction has been received (YES in step S201), the controller 111 proceeds to step S202. In a case where it is determined that a tuning instruction has not been received (NO in step S201), the controller 111 returns to step S201.

In step S202, the controller 111 searches for a program whose broadcast time period has been changed and that is scheduled to be broadcasted at the time of reception of the tuning instruction in step S201 on the basis of the original program schedule before the change of the broadcast time period. The processing performed by the controller 111 in step S202 will be described below.

First, the controller 111 extracts only programs to be broadcasted on the channel based on the tuning instruction received in step S201 from among programs included in a broadcast time period change management table, and creates a broadcast time period change management table only including the extracted programs. Specifically, the controller 111 creates, from a broadcast time period change management table, a broadcast time period change management table only including extracted programs indicated by terrestrial broadcast channel identification information that is the same as the channel identification information for identifying the channel based on the tuning instruction.

Then, the controller 111 searches for, among the programs in the created broadcast time period change management table, a program whose broadcast time period has been changed and that is scheduled to be broadcasted at the time of reception of the tuning instruction on the basis of the original program schedule before the change of the broadcast time period. Specifically, the controller 111 searches the created broadcast time period change management table for a program whose originally scheduled broadcast time period includes the time of reception of the tuning instruction. Note that in a case where the originally scheduled broadcast time exhibits a value “NULL”, the time of reception of the tuning instruction is not included.

In step S203, the controller 111 determines whether or not a program has been found in step S202. In a case where a program has been found in step S202 (YES in step S203), the controller 111 proceeds to step S204. Meanwhile, in a case where a program has not been found in step S202 (NO in step S203), the controller 111 proceeds to step S213.

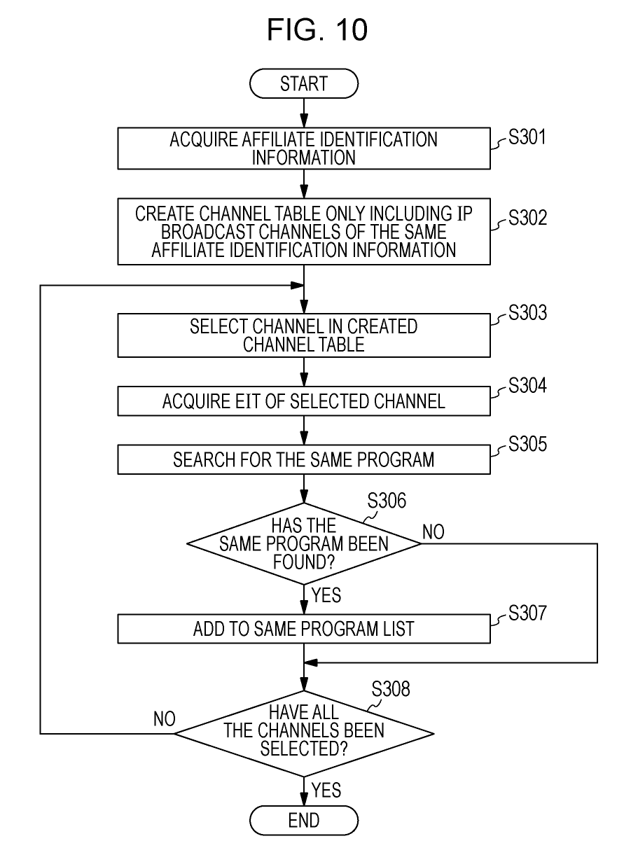

In step S204, the controller 111 performs a program search process for searching for the same program as the program found in step S202 from among IP broadcast programs. In the program search process, the controller 111 adds information on the same program to the same program list. The program search process will be described later with reference to a flowchart shown in FIG. 10.

In step S205, the controller 111 determines whether or not the same program has been found in step S204. In a case where the same program has been found in step S204 (YES in step S205), the controller 111 proceeds to step S206. Meanwhile, in a case where the same program has not been found in step S204 (NO in step S205), the controller 111 proceeds to step S213.

In step S206, the controller 111 selects a program from the same program list.

In step S207, the controller 111 determines whether or not the program selected in step S206 is scheduled to be broadcasted during the same broadcast time period as the originally scheduled broadcast time period of the program found in step S202. Specifically, the controller 111 acquires the broadcast time period of the program selected in step S206 from the EIT of IP broadcasts stored in the storing unit 108. The controller 111 also acquires, from the broadcast time period change management table, the originally scheduled broadcast time period associated with program identification information for identifying the program found in step S202.

Then, by comparing the broadcast time period with the originally scheduled broadcast time period, the controller 111 determines whether or not the program selected in step S206 is broadcasted during the same broadcast time period as the originally scheduled broadcast time period of the program found in step in S202. In a case where it is determined that the program selected in step S206 is broadcasted during the same broadcast time period as the originally scheduled broadcast time period of the program found in step S202 (YES in step S207), the controller 111 proceeds to step S208. Meanwhile, in a case where it is determined that the selected program is not broadcasted during the same broadcast time period as the originally scheduled broadcast time period (NO in step S207), the controller 111 proceeds to step S209.

In step S208, the controller 111 adds, to the IP broadcast channel identification information list associated with the program found in step S202, channel identification information on the IP broadcast channel on which the program selected in step S206 is broadcasted. Specifically, the controller 111 acquires, from the same program list, the channel identification information on the IP broadcast channel on which the program selected in step S206 is broadcasted. Then, the controller 111 adds the acquired channel identification information to the IP broadcast channel identification information list associated with the program identification information for identifying the program found in step S202 in the broadcast time period change management table.

In step S209, the controller 111 determines whether or not all the programs in the same program list have been selected in step S206. In a case where all the programs have not been selected (NO in step S209), the controller 111 returns to step S206 and continues to perform the process by selecting a new program from the same program list. Meanwhile, in a case where all the programs have been selected (YES in step S209), the controller 111 proceeds to step S210.

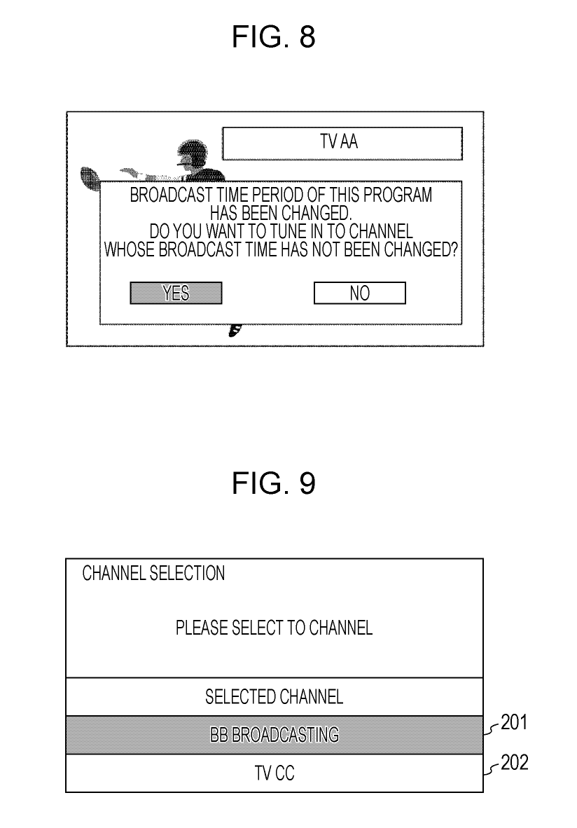

In step S210, the controller 111 displays a tuning confirmation screen on the display 104, as shown in FIG. 8, and determines whether or not the IP broadcast channel on which the same program as the program found in step S202 is broadcasted during the same broadcast time period as the originally scheduled broadcast time period of the program found in step S202 is to be tuned in. In a case where a user has selected “YES” on a viewing selection screen by using the remote control 109 (YES in step S210), the controller 111 proceeds to step S211. Meanwhile, in a case where the user has selected “NO” on the viewing selection screen (NO in step S210), the controller 111 proceeds to step S213.

In step S211, the controller 111 displays a channel selection screen on the display 104, as shown in FIG. 9, and determines whether or not a channel to be tuned in has been selected on the channel selection screen. The controller 111 displays the channel selection screen on the basis of the IP broadcast channel identification information list associated with the program identification information for identifying the program found in step S202 in the broadcast time period change management table. The “selected channel” is an IP broadcast channel on which the same program as the program found in step S202 is broadcasted during the same broadcast time period as the originally scheduled broadcast time period of the program found in step S202.

Referring to FIG. 9, selection buttons 201 and 202 for selecting a channel to be tuned in are displayed on the channel selection screen. The user selects a channel to be tuned in by selecting the selection button 201 or 202 by using the cursor key of the remote control 109 and then pressing the set key to determine the selected selection button 201 or 202. In a case where a channel to be tuned in has been selected on the channel selection screen (YES in step S211), the controller 111 proceeds to step S212. Meanwhile, in a case where a channel to be tuned in has not been selected on the channel selection screen (NO in step S211), the controller 111 returns to step S211.

In step S212, the controller 111 acquires, from the broadcast time period change management table, channel identification information on the IP broadcast channel selected in step S211, and notifies the IP broadcast receiver 101 of the acquired channel identification information. The IP broadcast receiver 101 is tuned in to the IP broadcast channel identified by the channel identification information notified from the controller 111.

In step S213, the controller 111 notifies the broadcast receiver 100 of the channel identification information on the channel for which the tuning instruction has been issued in step S201. The broadcast receiver 100 is tuned in to the channel identified by the channel identification information notified from the controller 111.

A program search process for searching for, among IP broadcast programs, the same program as a target program will now be described. The program search process is performed by the controller 111 in step S204 of the flowchart shown in FIG. 7. FIG. 10 shows the flowchart showing the program search process.

Note that at the start of the program search process, the controller 111 deletes information on all the programs managed in the same program list. In addition, in this embodiment, the target program is the program found in step S202.

In step S301, the controller 111 acquires affiliate identification information on a channel on which the target program is broadcasted. Specifically, the controller 111 acquires, from the broadcast time period change management table stored in the storing unit 108, terrestrial broadcast channel identification information associated with program identification information for identifying the target program. Then, the controller 111 acquires, from the channel table stored in the storing unit 108, affiliate identification information associated with the acquired terrestrial broadcast channel identification information.

In step S302, the controller 111 extracts, from the channel table, only IP broadcast channels having affiliate identification information that is the same as the affiliate identification information acquired in step S301, and creates a channel table only including the extracted channels.

In step S303, the controller 111 selects a channel by referring to the channel table created in step S302.

In step S304, the controller 111 acquires the EIT of the channel selected in step S303 from the storing unit 108. The television broadcast receiving apparatus according to this embodiment is capable of acquiring the EIT of an IP broadcast channel by tuning to the channel. Thus, the controller 111 acquires the channel identification information for identifying the channel selected in step S303 from the channel table created in step S302, and notifies the IP broadcast receiver 101 of the acquired channel identification information. Then, the IP broadcast receiver 101 performs a tuning operation on the basis of the channel identification information notified from the controller 111.

In step S305, the controller 111 searches for, among programs broadcasted on the channel selected in step S303, the same program as the target program. Specifically, the controller 111 searches for, among programs broadcasted on the channel selected in step S303, a program having the same name as the program name represented as the program identification information on the target program, by referring to program names included in the EIT acquired in step S304.

Note that in this embodiment, since a program name is used as program identification information, the same program as the target program is searched for by using the program name. However, information to be used for searching is not necessarily limited to a program name. Any type of information may be used as long as a program can be identified by the information.

In step S306, the controller 111 determines whether or not the same program as the target program has been found in step S305. In a case where the same program as the target program has been found (YES in step S306), the controller 111 proceeds to step S307. Meanwhile, in a case where the same program as the target program has not been found (NO in step S306), the controller 111 proceeds to step S308.

In step S307, the controller 111 adds, to the same program list, the program that is the same as the target program and that is broadcasted on the channel selected in step S303. Specifically, the controller 111 acquires the program name of the same program from the EIT acquired in step S304, and adds, as program identification information, the acquired program name to the same program list. Then, the controller 111 acquires channel identification information on the channel selected in step S303 from the channel table created in step S302, and sets the acquired channel identification information in association with the added program identification information.

In step S308, the controller 111 determines whether or not all the channels included in the channel table created in step S302 have been selected in step S303. In a case where all the channels have not been selected (NO in step S308), the controller 111 returns to step S303 and continues to perform the process by selecting a new channel from the channel table. Meanwhile, in a case where all the channels have been selected (YES in step S308), the controller 111 ends the process.

As described above, the television broadcast receiving apparatus according to this embodiment is capable of receiving, even in a case where the broadcast time period of a terrestrial broadcast program has been changed, image data and audio data of an IP broadcast program that is the same as the terrestrial broadcast program and that is broadcasted during the originally scheduled broadcast time period. Thus, with the television broadcast receiving apparatus according to this embodiment, a user who needs to view a program during the originally scheduled time period because, for example, the user cannot arrange a viewing time different from the originally scheduled time is able to view the program during the originally scheduled time period. Thus, user friendliness can be improved.

Note that although local television broadcasts are provided via terrestrial waves in this embodiment, the local television broadcasts are not necessarily provided via terrestrial waves. Any other broadcast waves may be employed as long as local television broadcasts can be provided.

In addition, although nation-wide television broadcasts are provided via IP broadcasting in this embodiment, nation-wide broadcasts are not necessarily provided via IP broadcasting. Any other types of broadcasting, such as cable television broadcasting, may be employed as long as nation-wide television broadcasts can be provided via a network.

In the first embodiment, in the tuning process shown in FIG. 7, the controller 111 performs a process for searching for, among IP broadcast programs, a program that is the same as a terrestrial broadcast program whose broadcast time period has been changed and that is broadcasted during the originally scheduled broadcast time period. However, in a case where the search process requires a long processing time, a long time is necessary for tuning and the response characteristics of the television broadcast receiving apparatus are thus degraded. Consequently, user friendliness may be degraded. In view of the above, in this modification, the controller 111 performs the search process in the broadcast time period change setting process.

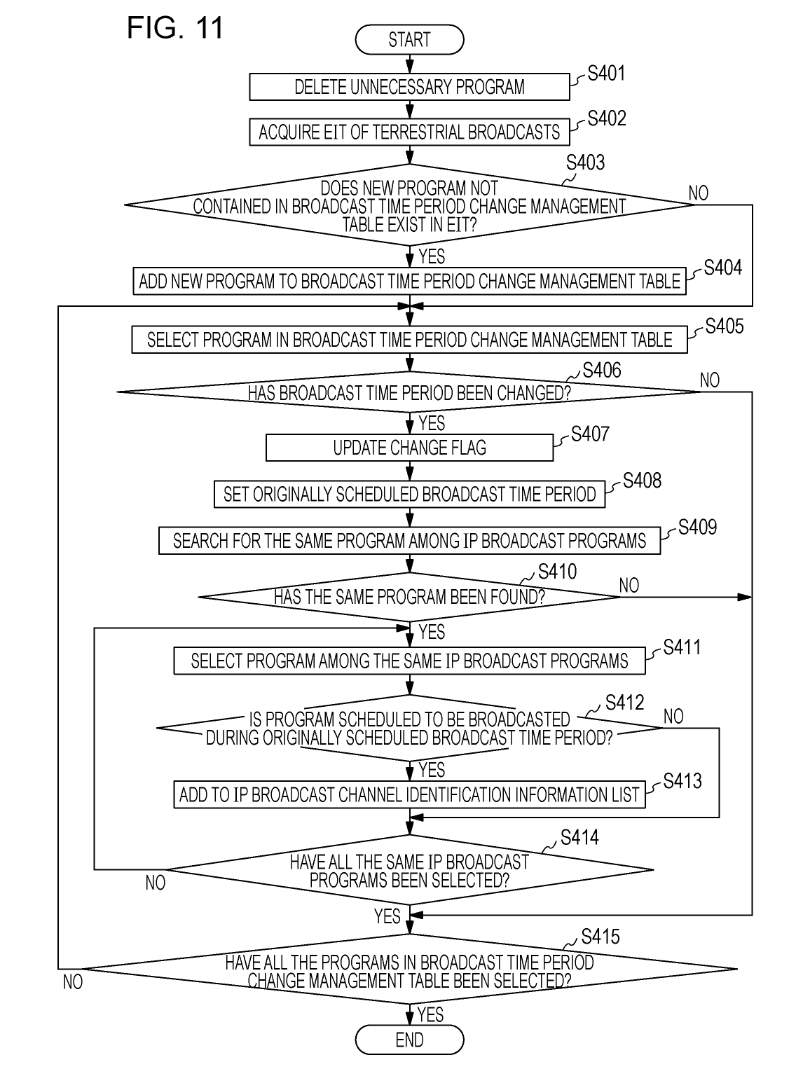

In a case where this modification is applied to the flowchart shown in FIG. 6, the process is performed in accordance with a flowchart shown in FIG. 11.

Since processing of steps S401 to S408 is similar to the processing of steps S101 to S108 shown in FIG. 6, the description of the processing of steps S401 to S408 will be omitted.

In step S409, the controller 111 performs a program search process for searching for, among IP broadcast programs, the same program as the program selected in step S405. The program search process is similar to the process represented by the flowchart shown in FIG. 10. However, a program to be searched for in this program search process is the same program as the program selected in step S405.

Since processing of steps S410 to S412 is similar to the processing of steps S205 to S207 shown in FIG. 7, the description of the processing of steps S410 to S412 will be omitted.

In step S413, the controller 111 adds, to the IP broadcast channel identification information list associated with the program selected in step S405, channel identification information on the IP broadcast channel on which the program selected in step S411 is broadcasted. Specifically, the controller 111 acquires, from the same program list, the channel identification information on the IP broadcast channel on which the program selected in step S411 is broadcasted. Then, the controller 111 adds the acquired channel identification information to the IP broadcast channel identification information list associated with the program identification information for identifying the program selected in step S405 in the broadcast time period change management table.

Since processing of step S414 is similar to the processing of step S209 shown in FIG. 7, the description of the processing of step S414 will be omitted.

In addition, since processing of step S415 is similar to the processing of step S109 shown in FIG. 6, the description of the processing of step S415 will be omitted.

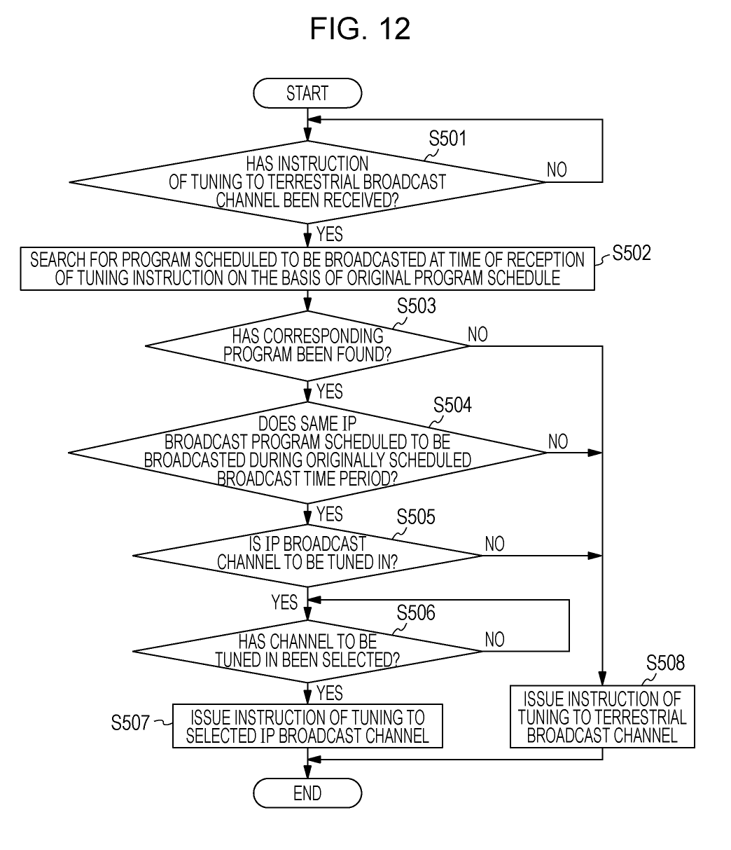

Then, in a case where this modification is applied to the flowchart shown in FIG. 7, the process is performed in accordance with a flowchart shown in FIG. 12.

Since processing of steps S501 to S503 is similar to the processing of steps S201 to S203 shown in FIG. 7, the description of the processing of steps S501 to S503 will be omitted.

In step S504, the controller 111 determines whether or not an IP broadcast program that is the same as the program found in step S502 and that is scheduled to be broadcasted during the originally scheduled broadcast time period exists. Specifically, the controller 111 acquires, from the broadcast time period change management table, an IP broadcast channel identification information list associated with program identification information for identifying the program found in step S502.

In a case where the value of the acquired IP broadcast channel identification information list is not “NULL”, the controller 111 determines that an IP broadcast program that is the same as the program found in step S502 and that is broadcasted during the originally scheduled broadcast time period exists. Meanwhile, in a case where the value of the acquired IP broadcast channel identification information list is “NULL”, the controller 111 determines that a corresponding IP broadcast program does not exist. In a case where it is determined that a corresponding IP broadcast program exists (YES in step S504), the controller 111 proceeds to step S505. Meanwhile, in a case where it is determined that a corresponding IP broadcast program does not exist (NO in step S504), the controller 111 proceeds to step S507.

Since processing of steps S505 to S508 is similar to the processing of steps S210 to S213 shown in FIG. 7, the description of the processing of steps S505 to S508 will be omitted.

As described above, according to this modification, in the tuning process, compared with a case where an IP broadcast program that is the same as a terrestrial broadcast program whose broadcast time period has been changed and that is scheduled to be broadcasted during the originally scheduled broadcast time period is searched for, a short time is required for tuning. Thus, user friendliness can be improved.

In a second embodiment, a method for, in a case where the broadcast time period of a program selected on an electronic program guide for terrestrial broadcasts has been changed, receiving image data and audio data of an IP broadcast program that is the same as the selected program and that is broadcasted during the originally scheduled broadcast time period will be described.

The controller 111 of a television broadcast receiving apparatus according to the second embodiment has features different from those of the controller 111 according to the modification of the first embodiment. Only differences between the second embodiment and the modification of the first embodiment will be described.

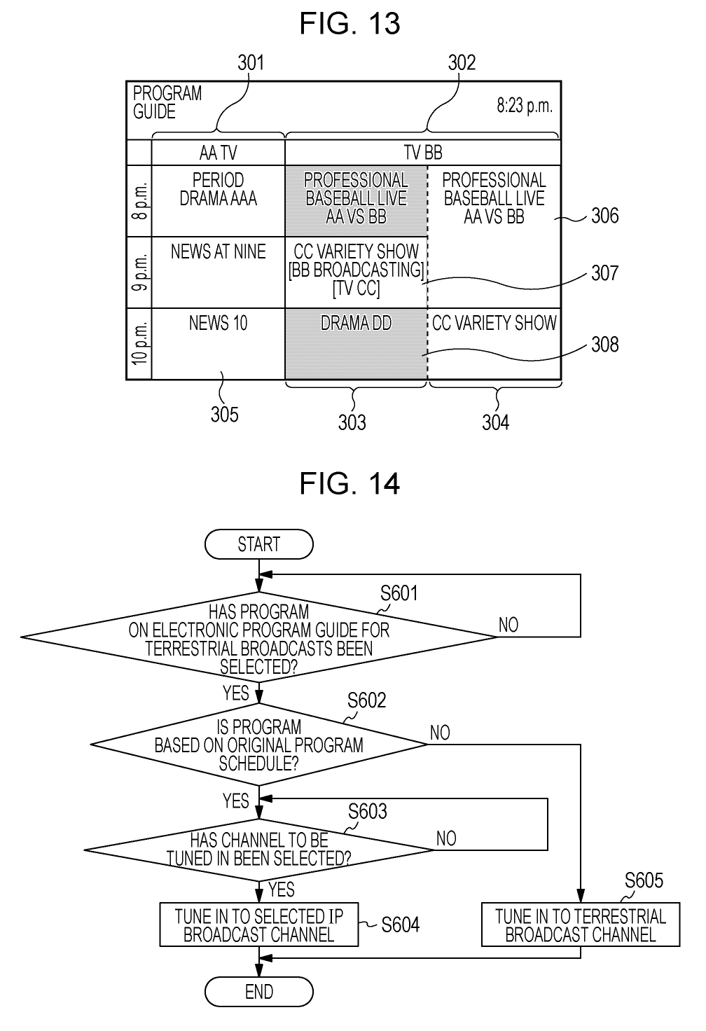

When receiving an instruction to display an electronic program guide for terrestrial broadcasts from the remote control receiver 110, the controller 111 displays the electronic program guide on the display 104 on the basis of the SI of terrestrial broadcasts and the broadcast time period change management table stored in the storing unit 108. In particular, in a case where a program whose broadcast time period has been changed exists among programs displayed in the electronic program guide, the controller 111 displays an electronic program guide for terrestrial broadcasts including information on a program based on the latest program schedule and information on a program based on the original program schedule before the change of the broadcast time period, as shown in FIG. 13.

In a case where a program has been selected on the electronic program guide for terrestrial broadcasts, the controller 111 instructs the broadcast receiver 100 or the IP broadcast receiver 101 to be tuned in to a channel on which the program is broadcasted. In particular, in a case where a program based on the original program schedule before a change of the broadcast time period has been selected on the electronic program guide, the controller 111 instructs the IP broadcast receiver 101 to be tuned in to an IP broadcast channel on which the same program as the selected program is broadcasted during the originally scheduled broadcast time period. Such a program selecting process will be described later with reference to FIG. 14.

The electronic program guide for terrestrial broadcasts including information on a program based on the latest program schedule and information on a program based on the original program schedule before changes of broadcast time periods will be described with reference to FIG. 13. The electronic program guide shown in FIG. 13 includes a display area 301 in which programs broadcasted on a channel of “AA TV” are displayed and a display area 302 in which programs broadcasted on a channel of “TV BB” are displayed.

Referring to the electronic program guide shown in FIG. 13, since the broadcast time period of a professional baseball live program broadcasted on the channel of TV BB is extended, the broadcast time periods of the professional baseball live program and the subsequent programs are changed. Thus, the display area 302 in which programs broadcasted on the channel of “TV BB” includes a display area portion 303 in which programs based on the original program schedule before the changes of the broadcast time periods are displayed and a display area portion 304 in which programs based on the latest program schedule are displayed. Meanwhile, since the broadcast time periods of programs broadcasted on the channel of “AA TV” are not changed, only programs based on the latest program schedule of the channel of “AA TV” are displayed in the display area 301.

In addition, each of the display area 301, the display area portion 303, and the display area portion 304 includes at least one or more cells defined by time periods. In cells of the display area 301, the names of programs broadcasted on the channel of “AA TV” during time periods defined by the cells are displayed. For example, since a program “NEWS 10” is broadcasted during a time period from 10:00 p.m. to 11:00 p.m. on the channel of “AA TV”, the program name “NEWS 10” is displayed in a cell 305 in FIG. 13.

Note that the controller 111 displays cells in the display area 301 on the basis of the SI of terrestrial broadcasts stored in the storing unit 108.

In cells of the display area portion 304, the names of programs broadcasted on the channel of “TV BB” during time periods defined by the cells are displayed on the basis of the latest program schedule. For example, since a program “PROFESSIONAL BASEBALL LIVE AA VS BB” is scheduled to be broadcasted during a time period from 8:00 p.m. to 10:00 p.m. on the channel of “TV BB” on the basis of the latest program schedule, the program name “PROFESSIONAL BASEBALL LIVE AA VS BB” is displayed in a cell 306 in FIG. 13.

Note that the controller 111 displays cells in the display area portion 304 on the basis of the SI of terrestrial broadcasts stored in the storing unit 108.

Meanwhile, in cells of the display area portion 303, the names and the like of programs broadcasted on the channel of “TV BB” during time periods defined by the cells are displayed on the basis of the original program schedule before the changes of the broadcast time periods. In particular, in a case where an IP broadcast channel on which the same program is broadcasted during the originally scheduled broadcast time period exists, the name of a broadcaster of the channel as well as the program name is displayed in a cell of the display area portion 303. In a case where an IP broadcast channel on which the same program is broadcasted during the originally scheduled broadcast time period does not exist, a corresponding cell in the display area portion 303 is displayed in gray so that the cell cannot be selected.

For example, referring to FIG. 13, a program “CC VARIETY SHOW” is scheduled to be broadcasted during a time period from 9:00 p.m. to 10:00 p.m. on the channel of “TV BB” on the basis of the original program schedule before a change of the broadcast time period. In addition, broadcasters “BB Broadcasting” and “TV CC” for IP broadcast channels are scheduled to broadcast “CC VARIETY SHOW” during the originally scheduled broadcast time period. Thus, in addition to the program name “CC VARIETY SHOW”, the broadcaster names “BB BROADCASTING” and “TV CC” are displayed in a cell 307.

However, in FIG. 13, although the program “DRAMA DD” is scheduled to be broadcasted during a time period from 10:00 p.m. to 11:00 p.m. on the channel of “TV BB” on the basis of the original program schedule before a change of the broadcast time period, no IP broadcast channel exists on which “DRAMA DD” is scheduled to be broadcasted during the originally scheduled broadcast time period. Thus, the program name “DRAMA DD” is displayed in gray in a cell 308 so that the cell 308 cannot be selected.

Note that the controller 111 displays cells in the display area portion 303 on the basis of the broadcast time period change management table stored in the storing unit 108. More specifically, the controller 111 acquires, from the broadcast time period change management table, information on a program that is broadcasted on the channel of “TV BB” and whose originally scheduled broadcast time period corresponds to a time period displayed in the electronic program guide, and displays a corresponding cell in the display area portion 303.

Note that in this embodiment, a program which is based on the original program schedule on the electronic program guide and whose broadcast time period is not changed is also displayed in gray so that the program cannot be selected.

A program selecting process for receiving, in a case where a program based on the original program schedule before changes of broadcast time periods is selected on an electronic program guide, image data and audio data of an IP broadcast program that is the same as the selected program and that is broadcasted during the originally scheduled broadcast time period will now be described. FIG. 14 is a flowchart showing the program selecting process. The program selecting process is performed by the controller 111 while an electronic program guide for terrestrial broadcasts is displayed.

In step S601, the controller 111 determines whether or not a program has been selected on an electronic program guide for terrestrial broadcasts. Specifically, in a case where a highlight moving instruction has been received from the remote control receiver 110 during the display of the electronic program guide, the controller 111 moves a highlighted portion on the electronic program guide on the basis of the instruction. Then, in a case where a selecting instruction has been received from the remote control receiver 110, the controller 111 determines that the highlighted program on the electronic program guide has been selected. In a case where it is determined that a program has been selected (YES in step S601), the controller 111 proceeds to step S602. Meanwhile, in a case where it is determined that no program has been selected (NO in step S601), the controller 111 returns to step S601.

In step S602, the controller 111 determines whether or not the program selected in step S601 is based on the original program schedule before changes of broadcast time periods. In a case where it is determined that the selected program is based on the original program schedule (YES in step S602), the controller 111 proceeds to step S603. Meanwhile, in a case where it is determined that the selected program is not based on the original program schedule (NO in step S602), the controller 111 proceeds to step S605.

Since processing of step S603 is similar to the processing of step S211 shown in FIG. 7, the description of the processing of step S603 will be omitted. However, in this embodiment, unlike the first embodiment, the controller 111 displays a channel selection screen on the basis of an IP broadcast channel identification information list associated with program identification information for identifying the program selected in step S601.

In step S604, the controller 111 notifies the IP broadcast receiver 101 of channel identification information on the IP broadcast channel selected in step S603. Then, the IP broadcast receiver 101 is tuned in to the IP broadcast channel identified by the channel identification information notified from the controller 111.

In step S605, the controller 111 notifies the broadcast receiver 100 of channel identification information on a terrestrial broadcast channel on which the program selected in step S601 is broadcasted. Then, the broadcast receiver 100 is tuned in to the terrestrial broadcast channel identified by the channel identification information notified from the controller 111.

As described above, the television broadcast receiving apparatus according to this embodiment is capable of receiving, in a case where the broadcast time period of a program selected on an electronic program guide for terrestrial broadcasts has been changed, image data and audio data of an IP broadcast program that is the same as the selected program and that is broadcasted during the originally scheduled broadcast time period. Thus, with the television broadcast receiving apparatus according to this embodiment, a user who needs to view a program during the originally scheduled time period because, for example, the user cannot arrange a viewing time different from the originally scheduled time is able to view the program during the originally scheduled time period. Thus, user friendliness can be improved.

In this embodiment, before displaying an electronic program guide for terrestrial broadcasts, the controller 111 searches for, in advance among IP broadcast programs, a program that is the same as a terrestrial broadcast program whose broadcast time period has been changed and that is broadcasted during the originally scheduled broadcast time period of the terrestrial broadcast program. However, the present invention is not limited to this. For example, in a case where a program whose broadcast time period has been changed is selected on an electronic program guide for terrestrial broadcasts, the controller 111 may search for, among IP broadcast programs, a program that is the same as the selected program and that is broadcasted during the originally scheduled broadcast time period of the selected program. In this case, first, the controller 111 performs the processing of steps S204 to S209 shown in FIG. 7, and then searches for, among IP broadcast programs, a program that is the same as the selected program. However, the program search process performed in step S204 is performed for a program that is selected on an electronic program guide for terrestrial broadcasts and whose broadcast time period has been changed.

Then, the controller 111 displays the channel selection screen shown in FIG. 9 for found IP broadcast channels on which the same IP broadcast program is broadcasted, and notifies the IP broadcast receiver 101 of channel identification information on a channel selected on the screen.

In a third embodiment, a method for receiving, even in a case where the broadcast time period of a terrestrial broadcast program for which a reservation has been made is changed, image data and audio data of an IP broadcast program that is the same as the program for which the reservation has been made and that is broadcasted during the originally scheduled broadcast time period, at the reserved viewing time will be described.

The storing unit 108 and the controller 111 of a television broadcast receiving apparatus according to the third embodiment have features different from those of the storing unit 108 and the controller 111 according to the first embodiment. Only differences between the third embodiment and the first embodiment will be described below.

The storing unit 108 stores reservation information on viewing reservation. The reservation information includes information on reservation of a program, such as program identification information on a reserved program, channel identification information on a reserved channel, and the broadcast time period of the reserved program.

The controller 111 generates reservation information on a reserved program on the basis of PSI and SI stored in the storing unit 108. Then, the controller 111 causes the storing unit 108 to store the generated reservation information.

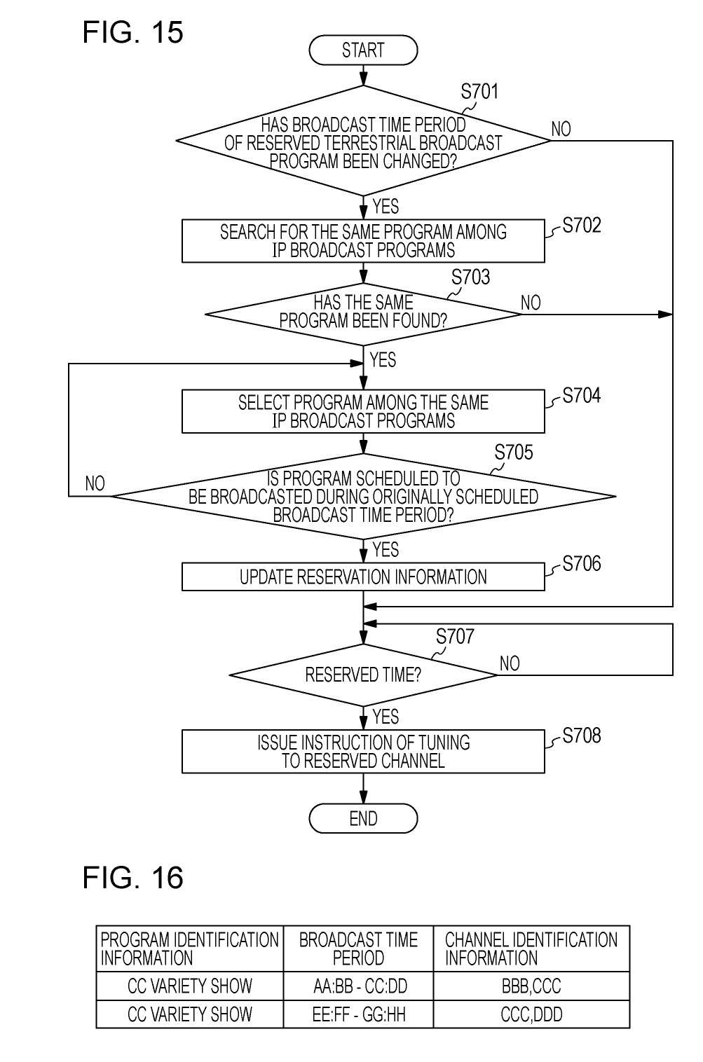

In addition, on the basis of the reservation information stored in the storing unit 108 and the current time acquired from the time manager 112, the controller 111 instructs the broadcast receiver 100 or the IP broadcast receiver 101 to be tuned in to a reserved channel on which the reserved program is scheduled to be broadcasted at the reserved time. Here, the reserved time represents the broadcast start time at which the reserved program starts. In particular, in a case where the broadcast time period of a reserved program is changed, a certain period of time before the reserved time, the controller 111 searches for, among IP broadcast programs, a program that is the same as the reserved program and that is scheduled to be broadcasted during the originally scheduled broadcast time period. Then, the controller 111 generates reservation information on the found IP broadcast program on the basis of the PSI and SI stored in the storing unit 108, and updates the reservation information stored in the storing unit 108. Such a reservation execution process will be described later with reference to a flowchart shown in FIG. 15.

A reservation execution process for receiving, in a case where the broadcast time period of a reserved terrestrial broadcast program has been changed, image data and audio data of an IP broadcast program that is the same as the reserved terrestrial broadcast program and that is scheduled to be broadcasted during the originally scheduled broadcast time period, at the reserved viewing time, will now be described. The reservation execution process is performed by the controller 111. FIG. 15 is a flowchart showing the reservation execution process. The reservation execution process starts a certain period of time before a reserved time. Although the reservation execution process starts one minute before the reserved time in this embodiment, the present invention is not limited to this.

In step S701, the controller 111 determines, on the basis of the broadcast time period change management table, whether or not the broadcast time period of a reserved terrestrial broadcast program has been changed. Specifically, in a case where a change flag associated with program identification information for identifying the reserved program exhibits “TRUE” in the broadcast time period change management table, the controller 111 determines that the broadcast time period of the reserved program has been changed.

Meanwhile, in a case where the change flag associated with the program identification information exhibits “FALSE” in the broadcast time period change management table, the controller 111 determines that the broadcast time period of the reserved time has not been changed. In a case where it is determined that the broadcast time period of the reserved terrestrial broadcast program has been changed (YES in step S701), the controller 111 proceeds to step S702. Meanwhile, in a case where it is determined that the broadcast time period of the reserved terrestrial broadcast program has not been changed (NO in step S701), the controller 111 proceeds to step S707.

In step S702, the controller 111 performs a program search process for searching for, among IP broadcast programs, the same program as the reserved program. The program search process is similar to the process represented by the flowchart shown in FIG. 10. However, a program to be searched for in this program search process is the same program as the reserved program.

Since processing of steps S703 to S705 is similar to the processing of steps S205 to S207 shown in FIG. 7, the description of the processing of steps S703 to S705 will be omitted.

In step S706, on the basis of the PSI and SI of IP broadcasts stored in the storing unit 108, the controller 111 generates reservation information on the program selected in step S704, and updates the reservation information stored in the storing unit 108.

In step S707, the controller 111 determines, on the basis of the broadcast time period of the reserved program included in the reservation information, whether or not the current time acquired from the time manager 112 is the reserved time. In a case where it is determined that the current time is the reserved time (YES in step S707), the controller 111 proceeds to step S708. Meanwhile, in a case where it is determined that the current time is not the reserved time (NO in step S707), the controller 111 returns to step S707.

In step S708, the controller 111 notifies the broadcast receiver 100 or the IP broadcast receiver 101 of channel identification information on the reserved channel on the basis of the reservation information stored in the storing unit 108. Specifically, in a case where reception type information associated with the channel identification information on the reserved channel in the channel table stored in the storing unit 108 indicates terrestrial broadcasting, the controller 111 notifies the broadcast receiver 100 of the channel identification information.

Meanwhile, in a case where the reception type information indicates IP broadcasting, the controller 111 notifies the IP broadcast receiver 101 of the channel identification information. The broadcast receiver 100 or the IP broadcast receiver 101 is tuned in to the channel identified by the channel identification information notified from the controller 111.

As described above, the television broadcast receiving apparatus according to this embodiment is capable of receiving, even in a case where the broadcast time period of a reserved terrestrial broadcast program has been changed, image data and audio data of an IP broadcast program that is the same as the reserved program and that is scheduled to be broadcasted during the originally scheduled broadcast time period, at the reserved viewing time. Thus, with the television broadcast receiving apparatus according to this embodiment, a user who needs to view a program during the originally scheduled time period because, for example, the user cannot arrange a viewing time different from the originally scheduled time is able to view the program during the originally scheduled time period, without making a new viewing reservation. Thus, user friendliness can be improved.

In a fourth embodiment, a method for searching for a program whose broadcast time period has no possibility of being changed and registering a viewing reservation of the found program, at the time of registration of a viewing reservation, will be described.

The storing unit 108 and the controller 111 of a television broadcast receiving apparatus according to the fourth embodiment have features different from those of the storing unit 108 and the controller 111 in the third embodiment. Only differences between the fourth embodiment and the third embodiment will be described below.

The storing unit 108 stores a reservation candidate program list that is used in the reservation registration process described later. The reservation candidate program list is a list of IP broadcast programs which are the same as a terrestrial broadcast program and whose broadcast time periods have no possibility of being changed. Specifically, in the reservation candidate program list, program identification information on a program, the broadcast time period of the program, and channel identification information on an IP broadcast channel on which the program is broadcasted are associated with each other, as shown in FIG. 16.

The controller 111 generates reservation information on a program selected by a user by using the remote control 109 on an electronic program guide for terrestrial broadcasts, and causes the storing unit 108 to store the generated reservation information. However, in a case where it is determined that the broadcast time period of the selected program has a possibility of being changed, the controller 111 generates reservation information on an IP broadcast program that is the same as the selected program and whose broadcast time period has no possibility of being changed, and causes the storing unit 108 to store the generated reservation information.

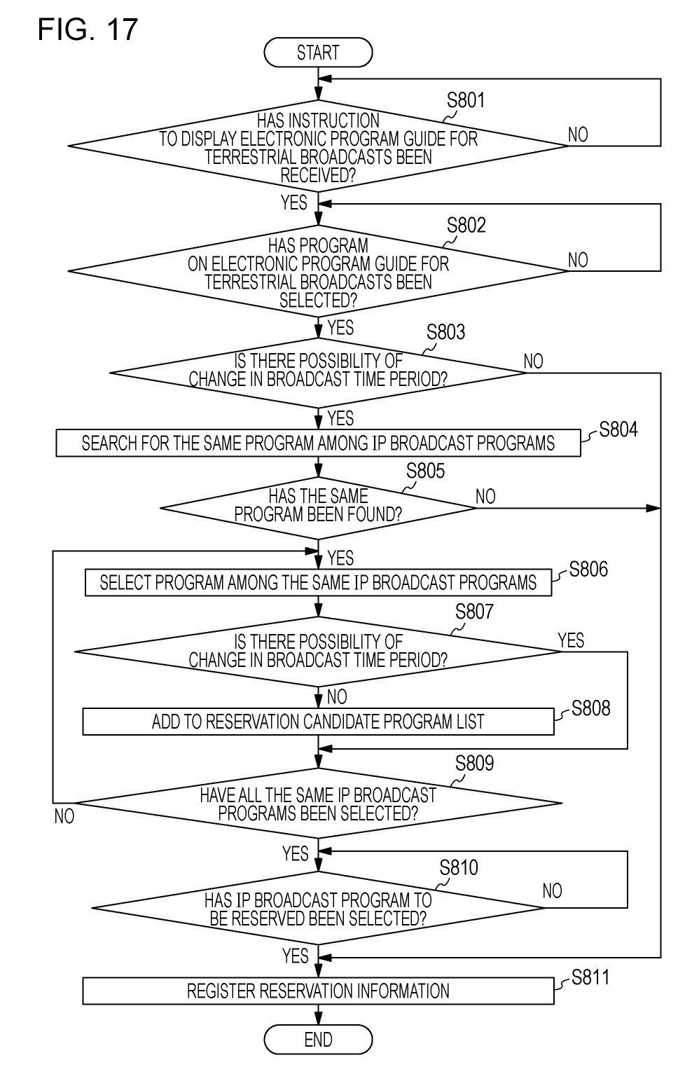

Note that the controller 111 determines, on the basis of the EIT of terrestrial broadcasts or the EIT of IP broadcasts, whether or not the broadcast time period of a program has a possibility of being changed. In addition, the controller 111 generates reservation information on the basis of the PSI and SI of terrestrial broadcasts or the PSI and SI of IP broadcasts. The reservation registration process performed by the controller 111 as described above will be described below with reference to a flowchart shown in FIG. 17.

A reservation registration process for making a viewing reservation of a program whose broadcast time period has no possibility of being changed will now be described. FIG. 17 is a flowchart showing the reservation registration process. Note that at the start of the reservation registration process, the controller 111 deletes information on all the programs from the reservation candidate program list.

In step S801, the controller 111 determines whether or not an instruction to display an electronic program guide for terrestrial broadcasts has been received from the remote control receiver 110. In a case where it is determined that a display instruction has been received (YES in step S801), the controller 111 proceeds to step S802. Meanwhile, in a case where it is determined that no display instruction has been received (NO in step S801), the controller 111 returns to step S801.

Since processing of step S802 is similar to the processing of step S601 shown in FIG. 14, the description of the processing of step S802 will be omitted.

In step S803, the controller 111 determines whether or not the broadcast time period of a program subjected to determination has a possibility of being changed. In step S803, the program subjected to determination is the program selected in step S802. Specifically, the controller 111 determines, by using “user_nibble” within the content descriptor contained in the EIT of the program subjected to determination, whether or not the broadcast time period of the program subjected to determination has a possibility of being changed. The EIT of the program subjected to determination is stored in the storing unit 108.

Here, “user_nibble” represents information indicating that the program has a possibility of being canceled, the broadcast time period of the program has a possibility of being extended, or the like. For example, in a case where the values of the upper four bits and the lower four bits of “user_nibble” are “0×0 (hexadecimal number)” and “0×0 (hexadecimal number)”, “user_nibble” indicates that the program has a possibility of being canceled. In addition, in a case where the values of the upper four bits and the lower four bits of “user nibble” are “0×0 (hexadecimal number)” and “0×1 (hexadecimal number)”, “user nibble” indicates that the broadcast time period of the program has a possibility of being extended.

In step S803, in a case where at least one of condition (a) and condition (b) is met, the controller 111 determines that the broadcast time period of the program subjected to determination has a possibility of being changed.

Condition (a): A case where the broadcast time period of a program subjected to determination or the broadcast time period of any one of programs scheduled to be broadcasted within a time period from a certain period of time before the broadcast start time of the program subjected to determination to the broadcast start time of the program subjected to be determination has a possibility of being extended. Specifically, a case where “user_nibble” of the program subjected to determination or “user_nibble” of any one of the programs scheduled to be broadcasted within the time period from a certain period of time before the broadcast start time of the program subjected to be determination to the broadcast start time of the program subjected to determination indicates that the broadcast time period of the program has a possibility of being extended. Note that although “a certain period of time before the broadcast start time of a program subjected to determination” is set to “six hours before the broadcast start time of the program subjected to determination” in this embodiment, the present invention is not limited to this.

Condition (b): A case where the program subjected to determination has a possibility of being canceled. Specifically, a case where “user_nibble” of the program subjected to determination indicates that the program subjected to determination has a possibility of being canceled.

In a case where neither condition (a) nor (b) is met, the controller 111 determines that the broadcast time period of the program subjected to determination has no possibility of being changed. In a case where it is determined that the broadcast time period of the program subjected to determination has a possibility of being changed (YES in step S803), the controller 111 proceeds to step S804. Meanwhile, in a case where it is determined that the broadcast time period of the program subjected to determination has no possibility of being changed (NO in step S803), the controller 111 proceeds to step S811.

In step S804, the controller 111 performs a program search process for searching for, among IP broadcast programs, the same program as the program selected in step S802. The program search process is similar to the process represented by the flowchart shown in FIG. 10. However, a program to be searched for in this program search process is the same program as the program selected in step S802.

Since processing of steps S805 to S806 is similar to the processing of steps S205 to S206 shown in FIG. 7, the description of the processing of steps S805 to S806 will be omitted.

In step S807, the controller 111 determines whether or not the broadcast time period of the program selected in step S806 has a possibility of being changed. The determination processing of step S807 is similar to the determination processing of step S803. However, a program subjected to determination in this determination processing is the program selected in step S806. In a case where it is determined that the broadcast time period of the program selected in step S806 has no possibility of being changed (NO in step S807), the controller 111 proceeds to step S808. Meanwhile, in a case where it is determined that the broadcast time period of the program selected in step S806 has a possibility of being changed (YES in step S807), the controller 111 proceeds to step S809.

In step S808, the controller 111 adds, to the reservation candidate program list, information on the program for which it is determined in step S807 that the broadcast time period has no possibility of being changed. First, the controller 111 acquires, from the same program list, program identification information on the program selected in step S806, and adds the acquired program identification information to the reservation candidate program list.

Then, the controller 111 acquires the broadcast time period of the program from the EIT of IP broadcasts stored in the storing unit 108, and sets the acquired broadcast time period in association with the added program identification information. Then, the controller 111 acquires channel identification information on an IP broadcast channel on which the program selected in step S806 is broadcasted from the same program list, and sets the acquired channel identification information in association with the added program identification information.

Since processing of step S809 is similar to the processing of step S209 shown in FIG. 7, the description of the processing of step S809 will be omitted.

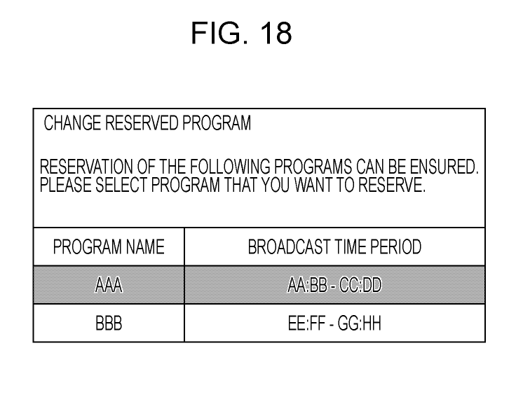

In step S810, the controller 111 displays a reservation program selection screen on the basis of the reservation candidate program list, as shown in FIG. 18. Then, in a case where the user has selected a program to be reserved on the screen by using the remote control 109 (YES in step S810), the controller 111 proceeds to step S811. Meanwhile, in a case where the user has not selected a program to be reserved (NO in step S810), the controller 111 returns to step S810.

In step S811, the controller 111 generates reservation information on an IP broadcast program or a terrestrial broadcast program, and causes the storing unit 108 to store the generated reservation information. Here, in a case where a program to be reserved has been selected in step S810, the controller 111 generates reservation information on the selected program on the basis of the PSI and SI of IP broadcasts stored in the storing unit 108.

Meanwhile, in a case where it is determined in step S803 that the broadcast time period of the program selected in step S802 has no possibility of being changed, the controller 111 generates reservation information on the program on the basis of the PSI and SI of terrestrial broadcasts stored in the storing unit 108.

In addition, in a case where an IP broadcast program that is the same as the program selected in step S802 has not been found in step S805, the controller 111 also generates reservation information on the program selected in step S802 on the basis of the PSI and SI of terrestrial broadcasts.

As described above, even in a case where the broadcast time period of a terrestrial broadcast program has a possibility of being changed, the television broadcast receiving apparatus according to this embodiment is capable of searching for an IP broadcast program that is the same as the terrestrial broadcast program and whose broadcast time period has no possibility of being changed, and registering a viewing reservation of the found IP broadcast program. Thus, with the television broadcast receiving apparatus according to this embodiment, a user who needs to view a program during the originally scheduled time period because, for example, the user cannot arrange a viewing time different from the originally scheduled time is able to view the program during the originally scheduled time period, by making a viewing reservation of a program whose broadcast time period has no possibility of being changed. Thus, user friendliness can be improved.

Note that although, in the determination processing of determining whether or not the broadcast time period of a program has a possibility of being changed, “user_nibble” indicating that the program has a possibility of being canceled or the broadcast time period of the program has a possibility of being extended is employed in this embodiment. However, information indicated by “user_nibble” does not necessarily relate to cancellation or extension. For example, “user nibble” may indicate that the program has a possibility of being interrupted.

In addition, although determination of whether or not the broadcast time period of a program has a possibility of being changed is performed on the basis of the EIT of terrestrial broadcasts or the EIT of IP broadcasts in this embodiment, the present invention is not limited to this. For example, information indicating that the broadcast time period of a program has a possibility of being extended may be acquired from a server on the Internet operated by a broadcaster so that determination of whether or not the broadcast time period of the program has a possibility of being changed can be performed on the basis of the acquired information.

As described above, according to an aspect of the present invention, user friendliness can be improved by receiving image data of a program during the originally scheduled time period.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-061286 filed Mar. 11, 2008, which is hereby incorporated by reference herein in its entirety.

What is claimed is:

1. A television broadcast receiving apparatus including a receiving unit capable of receiving image data of programs via a broadcast wave and a network, the television broadcast receiving apparatus comprising:
an acquisition unit configured to acquire a broadcast time period of a program broadcasted via the broadcast wave;
a storing control unit configured to cause a storing unit to store the broadcast time period acquired by the acquisition unit;
a determining unit configured to compare, in a case where the acquisition unit acquires the broadcast time period of the program broadcasted via the broadcast wave, the broadcast time period with an already-acquired broadcast time period of the program that has been acquired and stored in the storing unit, and to determine, in a case where the broadcast time period and the already-acquired broadcast time period differ from each other, that the broadcast time period of the program has been changed;
a setting unit configured to set, as an originally scheduled broadcast time period, an originally scheduled broadcast time period of a program for which it is determined by the determining unit that the broadcast time period has been changed, in the storing unit;
an instructing unit configured to issue an instruction of tuning to a broadcast wave channel;
a search unit configured to search for, in a case where a program whose tuning time is within the originally scheduled broadcast time period exists among programs that are scheduled to be broadcasted on the channel tuned in accordance with the instruction from the instructing unit and that have originally scheduled broadcast time periods, among programs broadcasted via the network, the same program that is scheduled to be broadcasted during the originally scheduled broadcast time period of the program; and
a control unit configured to control, in a case where the same program has been found by the search unit, the receiving unit to receive image data of the found program.

2. A television broadcast receiving apparatus including a receiving unit capable of receiving image data of programs via a broadcast wave and a network, the television broadcast receiving apparatus comprising:
an acquisition unit configured to acquire a broadcast time period of a program broadcasted via the broadcast wave;
a storing control unit configured to cause a storing unit to store the broadcast time period acquired by the acquisition unit;
a determining unit configured to compare, in a case where the acquisition unit acquires the broadcast time period of the program broadcasted via the broadcast wave, the broadcast time period with an already-acquired broadcast time period of the program that has been acquired and stored in the storing unit, and to determine, in a case where the broadcast time period and the already-acquired broadcast time period differ from each other, that the broadcast time period of the program has been changed;
a setting unit configured to set, as an originally scheduled broadcast time period, an originally scheduled broadcast time period of a program for which it is determined by the determining unit that the broadcast time period has been changed, in the storing unit;
a display control unit configured to cause a display unit to display an electronic program guide for programs broadcasted via the broadcast wave;
a selecting unit configured to select a program on the electronic program guide;
a search unit configured to search for, in a case where the program selected by the selecting unit is the program for which it is determined by the determining unit that the broadcast time period has been changed, among programs broadcasted via the network, the same program that is scheduled to be broadcasted during the same broadcast time period as the originally scheduled broadcast time period of the program selected by the selecting unit; and
a control unit configured to control, in a case where the same program has been found by the search unit, the receiving unit to receive image data of the found program.

3. The television broadcast receiving apparatus according to claim 2,
wherein in a case where the program for which it is determined by the determining unit that the broadcast time period has been changed exists among the programs displayed in the electronic program guide, the display control unit causes the display unit to display the electronic program guide, which includes the latest program schedule and the original program schedule before the change of the broadcast time period, and
wherein in a case where the determining unit determines that the program selected by the selecting unit is based on the original program schedule before the change of the broadcast time period and that the broadcast time period of the selected program has been changed, the search unit searches for, among programs broadcasted via the network, a program that is the same as the program selected by the selecting unit and that is scheduled to be broadcasted during the same broadcast time period as the originally scheduled broadcast time period of the selected program stored in the storing unit.

4. A television broadcast receiving apparatus including a receiving unit capable of receiving image data of programs via a broadcast wave and a network, the television broadcast receiving apparatus comprising:
an acquisition unit configured to acquire a broadcast time period of a program broadcasted via the broadcast wave;
a storing control unit configured to cause a storing unit to store the broadcast time period acquired by the acquisition unit;
a determining unit configured to compare, in a case where the acquisition unit acquires the broadcast time period of the program broadcasted via the broadcast wave, the broadcast time period with an already-acquired broadcast time period of the program that has been acquired and stored in the storing unit, and to determine, in a case where the broadcast time period and the already-acquired broadcast time period differ from each other, that the broadcast time period of the program has been changed;
a setting unit configured to set, as an originally scheduled broadcast time period, an originally scheduled broadcast time period of a program for which it is determined by the determining unit that the broadcast time period has been changed, in the storing unit;
a search unit configured to search for, in a case where a program broadcasted via the broadcast wave for which a viewing reservation has been made is the program for which it is determined by the determining unit that the broadcast time period has been changed, among programs broadcasted via the network, the same program that is scheduled to be broadcasted during the same broadcast time period as the originally scheduled broadcast time period of the reserved program stored in the storing unit, before the reserved viewing is performed; and
a control unit configured to control, in a case where the same program has been found by the search unit, the receiving unit to receive image data of the found program.

5. A television broadcast receiving apparatus including a receiving unit capable of receiving image data of programs via a broadcast wave and a network and program information on the programs, the television broadcast receiving apparatus comprising:
a determining unit configured to determine whether or not a broadcast time period of a program broadcasted via the broadcast wave has a possibility of being changed, on the basis of program information on the program received by the receiving unit;
a selecting unit configured to select a program broadcasted via the broadcast wave;
a search unit configured to search for, in a case where the determining unit determines that the broadcast time period of the program selected by the selecting unit has a possibility of being changed, among programs broadcasted via the network, the same program whose broadcast time period has no possibility of being changed, on the basis of the program information on the program received by the receiving unit;
a generating unit configured to generate, in a case where the same program has been found by the search unit, reservation information on a viewing reservation of the found program;
a storing unit configured to store the reservation information generated by the generating unit; and
a control unit configured to control the receiving unit to receive image data of the found program for which the viewing reservation has been made, on the basis of the reservation information stored in the storing unit.

6. A control method for controlling a television broadcast receiving apparatus including a receiving unit capable of receiving image data of programs via a broadcast wave and a network, the control method comprising:
acquiring a broadcast time period of a program broadcasted via the broadcast wave;
causing a storing unit to store the acquired broadcast time period;
comparing, in a case where the broadcast time period of the program broadcasted via the broadcast wave is acquired, the broadcast time period with an already-acquired broadcast time period of the program that has been acquired and stored in the storing unit, and determining, in a case where the broadcast time period and the already-acquired broadcast time period differ from each other, that the broadcast time period of the program has been changed;
setting, as an originally scheduled broadcast time period, an originally scheduled broadcast time period of a program for which it is determined that the broadcast time period has been changed, in the storing unit;
tuning to a broadcast wave channel in accordance with a user instruction;
searching for, in a case where a program whose tuning time is within the originally scheduled broadcast time period exists among programs that are scheduled to be broadcasted on the tuned channel and that have originally scheduled broadcast time periods, among programs broadcasted via the network, the same program that is scheduled to be broadcasted during the originally scheduled broadcast time period of the program; and
controlling, in a case where the same program has been found by the searching, the receiving unit to receive image data of the found program.

7. A control method for controlling a television broadcast receiving apparatus including a receiving unit capable of receiving image data of programs via a broadcast wave and a network, the control method comprising:
acquiring a broadcast time period of a program broadcasted via the broadcast wave;
causing a storing unit to store the acquired broadcast time period;
comparing, in a case where the broadcast time period of the program broadcasted via the broadcast wave is acquired, the broadcast time period with an already-acquired broadcast time period of the program that has been acquired and stored in the storing unit, and determining, in a case where the broadcast time period and the already-acquired broadcast time period differ from each other, that the broadcast time period of the program has been changed;
setting, as an originally scheduled broadcast time period, an originally scheduled broadcast time period of a program for which it is determined that the broadcast time period has been changed, in the storing unit;
causing a display unit to display an electronic program guide for programs broadcasted via the broadcast wave;
selecting a program on the electronic program guide in accordance with a user instruction;
searching for, in a case where the selected program is the program for which it is determined that the broadcast time period has been changed, among programs broadcasted via the network, the same program that is scheduled to be broadcasted during the same broadcast time period as the originally scheduled broadcast time period of the selected program; and
controlling, in a case where the same program has been found by the searching, the receiving unit to receive image data of the found program.

8. The control method according to claim 7,
wherein in a case where the program for which it is determined that the broadcast time period has been changed exists among the programs displayed in the electronic program guide, in the step of causing the display unit to display the electronic program guide, the electronic program guide, which includes the latest program schedule and the original program schedule before the change of the broadcast time period, is displayed on the display unit, and
wherein in a case where it is determined that the selected program is based on the original program schedule before the change of the broadcast time period and that the broadcast time period of the selected program has been changed, in the step of searching, a program that is the same as the selected program and that is scheduled to be broadcasted during the same broadcast time period as the originally scheduled broadcast time period of the selected program stored in the storing unit is searched for, among programs broadcasted via the network.

9. A control method for controlling a television broadcast receiving apparatus including a receiving unit capable of receiving image data of programs via a broadcast wave and a network, the control method comprising:
acquiring a broadcast time period of a program broadcasted via the broadcast wave;
causing a storing unit to store the acquired broadcast time period;
comparing, in a case where the broadcast time period of the program broadcasted via the broadcast wave is acquired, the broadcast time period with an already-acquired broadcast time period of the program that has been acquired and stored in the storing unit, and determining, in a case where the broadcast time period and the already-acquired broadcast time period differ from each other, that the broadcast time period of the program has been changed;
setting, as an originally scheduled broadcast time period, an originally scheduled broadcast time period of a program for which it is determined that the broadcast time period has been changed, in the storing unit;
searching for, in a case where a program broadcasted via the broadcast wave for which a viewing reservation has been made is the program for which it is determined that the broadcast time period has been changed, among programs broadcasted via the network, the same program that is scheduled to be broadcasted during the same broadcast time period as the originally scheduled broadcast time period of the reserved program stored in the storing unit, before the reserved viewing is performed; and
controlling, in a case where the same program has been extracted by the searching, the receiving unit to receive image data of the extracted program when the reserved viewing is performed.

10. A control method for controlling a television broadcast receiving apparatus including a receiving unit capable of receiving image data of programs via a broadcast wave and a network and program information on the programs, the control method comprising:
determining whether or not a broadcast time period of a program broadcasted via the broadcast wave has a possibility of being changed, on the basis of program information on the program received by the receiving unit;
selecting a program broadcasted via the broadcast wave in accordance with a user instruction;
searching for, in a case where it is determined that the broadcast time period of the selected program has a possibility of being changed, among programs broadcasted via the network, the same program whose broadcast time period has no possibility of being changed, on the basis of the program information on the program received by the receiving unit;
generating, in a case where the same program has been extracted by the searching, reservation information on a viewing reservation of the found program;
causing a storing unit to store the generated reservation information; and
controlling the receiving unit to receive image data of the extracted program for which the viewing reservation has been made, on the basis of the reservation information stored in the storing unit.
